(19) United States
(12) Patent Application Publication
(10) Pub. No.: US 2005/0035700 A1
(43) Pub. Date: Feb. 17, 2005

(54) Discharge lamp and illuminating device

(76) Inventors: Hidetoshi Yano, Chome Imabari-shi Ehime (JP); Noguchi Hidehiko, Imabari-shi Ehime (JP)

Correspondence Address: BANNER & WITCOFF, 1001 G STREET N W, SUITE 1100, WASHINGTON, DC, 20001, US

(21) Appl. No.: 10/496,068

(22) PCT Filed: Nov. 19, 2002
(86) PCT No.: PCT/JP02/12067

(30) Foreign Application Priority Data
Nov. 20, 2001 (JP) 2001-355200

(51) Int. Cl. H01J 65/00; H01J 11/00; H01J 17/44; H01J 61/54

(52) U.S. Cl. 313/234; 313/607; 313/594

(57) ABSTRACT

The discharge lamp according to the present invention is composed of a slender translucent airtight vessel 1a, an inner electrode 1c fixed inside one end of 1a, a discharge lamp 1 provided with a discharge medium composed mainly of rare gas, and an outer electrode 2 composed of a conductive wire arranged on the outer surface of translucent airtight vessel 1a. The outer electrode 2 is placed within a half circumference of the translucent airtight vessel in a first area 2a of the translucent airtight vessel 1a, which extends in a range between a top end of the inner electrode 1c and a position having a predetermined length in the forward direction of the translucent airtight vessel 1a. The outer electrode 2 is placed within an entire circumference of the translucent airtight vessel 1a in a second area 2b of the translucent airtight vessel 1a, which extends in the rest of the length of the translucent airtight vessel 1a.

### FIELD OF INVENTION

The present invention relates to a discharge lamp in which a discharge medium composed mainly of rare gas is enclosed, and a lighting device using the discharge lamp.

### BACKGROUND TECHNOLOGY

A discharge lamp enclosing a rare gas such as a xenon gas, which does not use mercury causing environmental problems, has such advantages that it does not inflict a significant influence to the environment when abandoned, and the brightness and the discharge voltage of the lamp are not influenced by the ambient temperature.

A discharge lamp having a structure shown in FIG. 1 and FIG. 2 is known as the discharge lamp using rare gas.

FIG. 1 and FIG. 2 are the side view and the longitudinal section of the conventional discharge lamp, respectively. In each figure, 101 is a glass tube of straight type, 102 is a phosphor layer, 103 is a lead-in wire, 104 is an inner electrode, 105 is an outer electrode, 106 is a translucent insulation tube, 107 is a lead wire, and 108 is a lighting circuit.

Both ends of the glass tube 101 are sealed, inside of which a discharge medium containing at least xenon is enclosed. The phosphor layer 102 is provided on an inner surface of the glass tube 101. The lead-in wire 103 is penetrating into the glass tube 101 from its one end where it is sealed airtight. The inner electrode 104, made of metal, is supported by the inner end of the lead-in wire 103, and is fixed in the glass tube 101. The outer electrode 105 is provided over a whole internal space length of the glass tube 101, and is formed by a conductive metal wire, which is wound in a coil. The outer electrode is arranged substantially in contact with the outer surface of the glass tube 101 along substantially full length in its longitudinal direction. The translucent insulator tube 106 covers the outer electrode 105 around the glass tube 101, fixing the outer electrode 105 thereon. The lead wire 107 is sealed on one end of the glass tube 101 so as not to be in contact with the discharge medium. An end portion of the winding outer electrode 105 is connected to the lead wire 107, which is used as a connecting means of the outer electrode 105 to outside devices.

When an output terminal of the lighting circuit 108 is connected between the lead-in wire 103 and the lead wire 107, a pulse voltage from the lighting circuit 108 will be applied between the inner electrode 104 of the discharge lamp and the outer electrode 105, occurring a discharge by the xenon in the glass tube 101. An ultraviolet ray, which is emitted from the xenon discharged, is converted into a visible light by exciting the phosphor layer 102. This visible light is used as a light source.

By the way, a lighting control is one of the performances required for this kind of discharge lamp. For example, in the case of the discharge lamp for automobiles, the discharge lamp is required to be lit stably under the lighting control ratio of down to 2%.

FIG. 3 depicts pulse waveforms showing a relation between the lighting control ratio and output pulse of the lighting circuit 108 when the lighting control ratio of the lighting circuit 108 is changed. FIG. 3(A) shows waveforms of the output pulses when the lighting control ratio is 100%. When a repetition frequency of the output pulses is assumed to be 20 kHz, for example, the repetition period is 50 μs. If a unit time is selected as 0.01 s (corresponding to a period of a repetition frequency of 100 Hz) for the output pulse, the number of the output pulses of the drive signal generating circuit 11 per unit time becomes 200 pulses. Namely, in case of the lighting control ratio of 100%, 200 pulses per unit time are repeatedly output at the frequency of 100 Hz.

FIG. 3(B) shows the waveforms of the output pulses in case the lighting control ratio is 5%. The number of the output pulses of the drive signal generating circuit 11 is ten pulses per unit time in this case.

FIG. 3(C) shows waveforms of the output pulses in case of the lighting control ratio of 1%. The number of the output pulses is one per unit time in this case.

When such lighting control is applied to the kind of discharge lamps shown in FIG. 1 and FIG. 2, there was a problem that when the lighting control ratio is small, a flicker arises near the inner electrode. When the lighting control ratio is 100%, a diffused positive column X is generated along a substantially entire length of a discharge space, as shown in FIG. 5. In such case, the positive column grows in nearly entire cross section of the discharge space along substantially the entire length of the discharge space, wherein no flicker is generated in the luminescence of the discharge lamp. On the other hand, when the lighting control ratio decreases to a small value, positive column, which used to be in the diffusion state, changes to a so-called contracted positive column Y, which is contracted to a thin line in the area of several cm length forward from the inner electrode, as shown in FIG. 5. Because the contracted positive column Y moves irregularly in the cross section of the electric discharge space, the flickering arises in the luminescence.

Here, FIG. 4 is a longitudinal section of the conventional discharge lamp showing diffusion positive column at the time of operation at the lighting control ratio of 100%. FIG. 5 is a longitudinal section showing the contracted positive column and the diffused positive column at the time of operation at the lighting control ratio of 2%, similarly.

Therefore, it is an object of the present invention to provide a discharge lamp, which is improved to minimize the flickering when lighting control ratio is decreased to small value and to provide a lighting device using the discharge lamps described above.

### DISCLOSURE OF THE INVENTION

The discharge lamp according to the present invention includes a slender tubular translucent airtight vessel, an inner electrode sealed in one end of the translucent air tight vessel, a discharge medium composed mainly of rare gas and sealed inside the translucent airtight vessel, and an outer electrode composed of a conductor wire which is arranged along the longitude direction and is substantially in contact with an outer surface of the translucent airtight vessel, in which the conductor wire is placed within a half circumference of the translucent airtight vessel in a first area of the translucent airtight vessel, which extends in a range between a top end of the inner electrode and a position having a predetermined length in the forward direction of the translucent airtight vessel, and in which the conductor wire is placed within an entire circumference of the translucent airtight vessel in a second area of the translucent airtight vessel, which extends in the rest of the length of the translucent airtight vessel.

According to the present invention, the contracted positive column is drawn to the outer electrode in the first area and stands still by the action of electric field, when a contracted positive column is generated in front of the inner electrode during the operation under the lighting control due to the outer electrode described above. Thus, a discharge lamp is provided in which the flickering is suppressed.

Further, in the discharge lamp of the present invention described above, the conductive wire, which constitutes the outer electrode, is desirable to be arranged on the straight line along the tube axis of the translucent airtight vessel in the first area. However, it is not necessarily arranged on the straight line but may be arranged on a curve, which is extending along the outer surface of the translucent airtight vessel in a range below 0.5 round, i.e., within a semicircle of the vessel, for continuing with the second area of the translucent airtight vessel.

The lighting device according to the present invention includes a main body, a discharge lamp described above in the main body, and a lighting circuit which lights the discharge lamp.

### BRIEF DESCRIPTION OF THE DRAWINGS

FIG. 1 is a side view showing a conventional discharge lamp.

FIG. 2 is a longitudinal section of FIG. 1.

FIG. 3 is a diagram of pulse waveforms showing a relation between the lighting control ratio and output pulse of the lighting circuit. The diagram shows a square-wave AC voltage waveform applied on a discharge lamp when the lighting control ratio is 100%.

FIG. 4 is a longitudinal section of a conventional electric discharge lamp showing a diffused positive column at the time when the lamp is lit at the control ratio of 100%.

FIG. 5 is a longitudinal section of a conventional electric discharge lamp showing a contracted positive column and the diffused positive column at the time when the lamp is lit at the lighting control ratio of 2%.

FIG. 6 is a side view showing a first embodiment of the discharge lamp according to the present invention.

FIG. 7 is a sectional view along line A-A′ shown in FIG. 6.

FIG. 8 is a longitudinal section of the discharge lamp shown in FIG. 6.

FIG. 9 is a graph showing a relation between a distance A (mm) of the first area and the tube electric power (W) of the discharge lamp shown in FIG. 6.

FIG. 10 is a side view showing a second embodiment of the discharge lamp according to the invention.

FIG. 11 is a sectional view along line A-A′ shown in FIG. 10.

FIG. 12 is a longitudinal section showing a third embodiment of the discharge lamp according to the present invention.

FIG. 13 is a graph showing a result of measurement showing a relation between a mean winding pitch (abscissa) of the third area 2c, and the lighting control ratio D (ordinate).

FIG. 14 is a longitudinal section showing a fourth embodiment of the discharge lamp according to the present invention.

FIG. 15 is a partial side view of a discharge lamp showing a structure at the end of the outer electrode in the fourth embodiment of the present invention.

FIG. 16 is a partial side view of an electric discharge lamp showing a fifth embodiment of the present invention.

FIG. 17 is a sectional view showing a back light device for a liquid crystal display as an embodiment of the lighting equipment of the present invention.

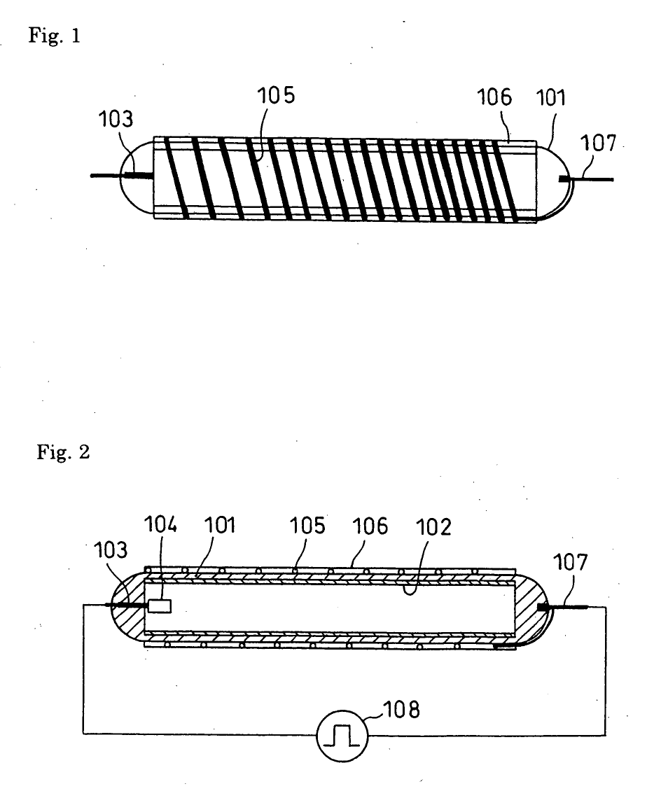

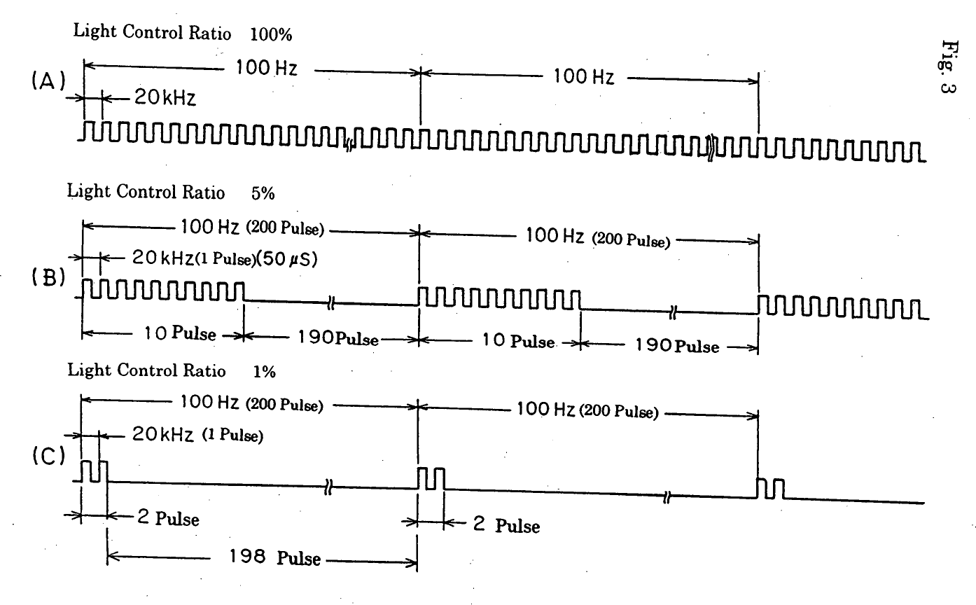

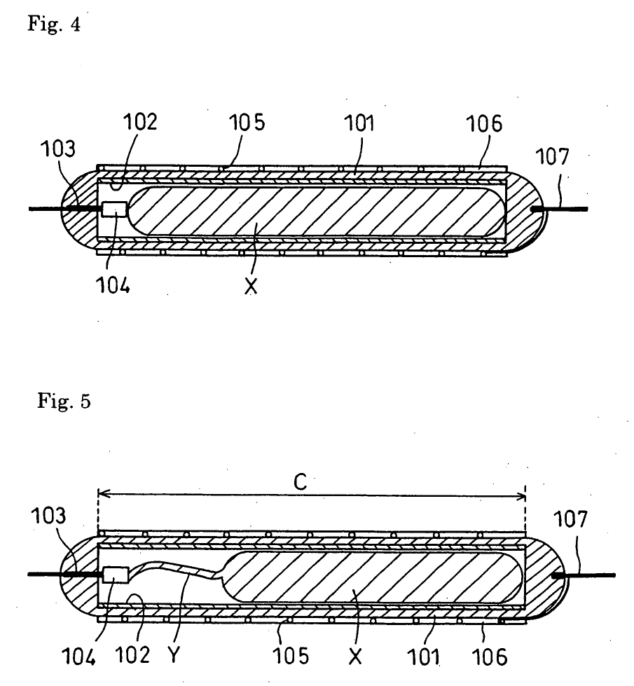

### DETAILED DESCRIPTION OF THE INVENTION

Hereafter, the embodiment of the present invention is explained with reference to the drawings.

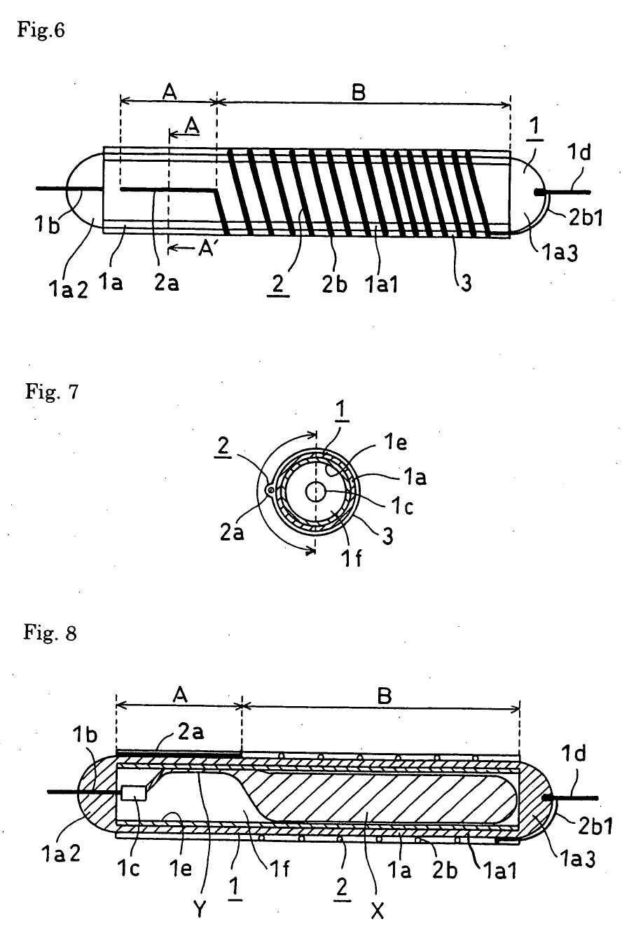

FIG. 6 to FIG. 9 show the first embodiment of the discharge lamp of the present invention, while, FIG. 6 is a side view, FIG. 7 is a transverse cross section along line A-A′ of FIG. 6, and FIG. 8 is a longitudinal cross section. In each figure, 1 is a discharge vessel, 2 is an outer electrode, and 3 is a translucent insulating coating.

As shown in these figures, the electric discharge lamp 1 is composed of a long and slender translucent airtight vessel 1a, a lead-in wire 1b, an inner electrode 1c, a lead wire 1d, a phosphor layer 1e, a discharge medium, and a discharge space 1f inside the translucent airtight vessel 1a.

The translucent airtight vessel 1a is equipped with a slender tubular portion 1a1 and first and second end portions 1a2 and 1a3, which seal the both ends of the tubular portion 1a1. The translucent airtight vessel 1a is made of hard glass in a long and slender shape. The first and the second end portions of the translucent airtight vessel 1a are composed mainly of bead stems of glass. The first and the second end portions 1a2 and 1a3 are formed by sealing a pair of bead stems at the both ends of the glass tube of the tubular portion 1a1.

The lead-in wire 1b airtightly penetrates the end portion 1a2 of translucent airtight vessel 1a. The lead-in wire 1b is made of such a sealing metal as Kovar at a portion penetrating the end portion 1a2. A Dumet wire is welded to the lead-in wire 1b at a portion outside of the translucent airtight vessel 1a.

The inner electrode 1c, constituting a cold cathode, is supported by welding at a tip of the lead-in wire 1b, and is provided inside the translucent airtight vessel 1a at one end thereof.

The lead wire 1d is provided so that it may not be exposed to discharge space 1f in the other end portion 1a3 of the translucent airtight vessel 1a, where the buried portion is made of Kovar and the projected portion outside is made of a Dumet wire.

The phosphor layer 1e consists of a phosphor of the type generating three wave lights and is formed on the inner surface of the translucent airtight vessel 1a.

The electric discharge medium is composed of a rare gas mainly consists of xenon, which is enclosed in the discharge space 1f of the discharge lamp 1.

The outer electrode 2 is an electrically conducting wire made of such a metal wire as nickel, which has different shapes in a first area 2a and a second area 2b. The first area 2a is provided in an area of length A along the tube axis of the translucent airtight container 1a, which extends from the tip of inner electrode 1c provided at the end portion of the translucent airtight vessel 1a toward the other end of the vessel 1a. In this area, the outer electrode 2 is made in the shape of a straight line along the tube axis. The second area 2b is provided in the rest portion having a length B along the tube axis of the translucent airtight container 1a. In this area, the outer electrode 2 is formed in the shape of a coil. In addition, also in any of the first and second areas 2a and 2b, the outer electrode 2 is provided contacting with the outer surface of the translucent airtight vessel 1a.

Here, the length A of the first area 2a is selected as 30 mm or less as will be mentioned later. Although the area where the contracted positive column is produced is usually within the range of about a few mm to 10 mm in front of the inner electrode (toward the other ends of translucent airtight vessel 1a), the range will be extended to 20-30 mm when the lamp is lit with a relatively high tube power. Therefore, according to the present invention, the contracted positive column can be drawn near to the outer electrode so that the flickering of luminescence can be suppressed despite of the tube electric power by selecting the predetermined distance as described above.

Then, the other end of the outer electrode 2 at the second area 2b is connected to the lead wire 1d fixed to the other ends of translucent airtight vessel 1a by welding etc. The voltage supply line from a high frequency power supply, which is similar to the power supply 108 shown in FIG. 2, is connected to the lead wire 1d.

The translucent insulation coating 3 is a tube, which consists of a transparent fluorocarbon resin of heat shrinkage type. The outer electrode 2 is fixed to the surface of the discharge lamp 1 and is covered by the translucent insulation coating 3 by inserting the discharge lamp 1 into the heat shrinkage tube and heating it.

Next, operation of the discharge lamp thus constituted is explained. When a pulse voltage of high frequency is supplied from the lighting circuit (not shown) between the inner electrode 1c of the discharge lamp 1 and the outer electrode 2, dielectric barrier discharge will occur in the discharge space 1f between the electrodes, and the discharge medium of xenon enclosed in the discharge space 1f will emit an ultraviolet ray. Since an ultraviolet ray irradiates phosphor layer 1e, the phosphor is excited to emit a visible light. That is, wavelength conversion of the ultraviolet ray is carried out into the visible light. Since the emitted visible light is radiated trough gaps formed between each turn of the coil of the outer electrode 2 around the entire outer surface of the translucent discharge lamp 1, the visible light can be used for the lighting equipment.

Further, when the lamp is lit under the small lighting control ratio, the contracted positive column Y arises in the area in front of the tip of the inner electrode 1c within the length of about 10 mm. However, the contracted positive column Y is drawn near to the first area 2a of the outer electrode 2, the conductor wire of which is put aside within a half circumference of the translucent airtight vessel, and stands still. Consequently, the flickering in luminescence is not generated.

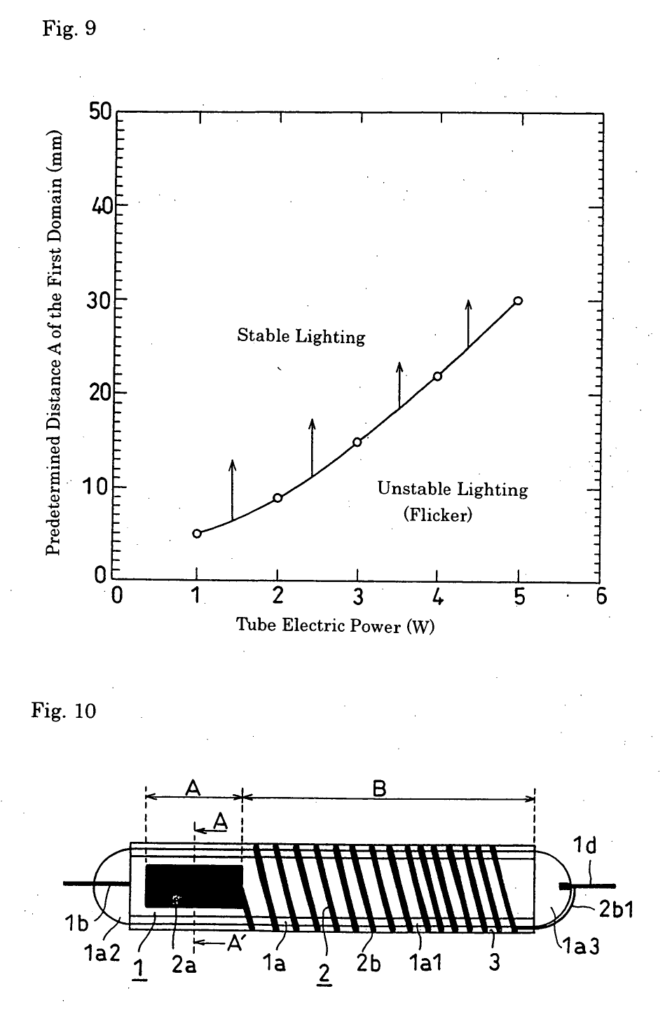

FIG. 9 is a graph showing a relation between a tube electric power (W) of a discharge lamp and the distance A (mm) of the first area 2a. In the figure, the abscissa indicates the tube electric power (W) and the ordinate indicates the distance A (mm) of the first area 2a, respectively. In FIG. 9, results of experiments are plotted, in which the discharge lamps having a structure shown in FIG. 6 to FIG. 8 and having a different length A from each other are lit under the various lighting control ratios. It became clear that, in the upper area of the curve in FIG. 9, a stable lighting of the discharge lamp, which suppresses the flickering in luminescence, could be obtained. However, in the area under the curve, unstable lighting of the discharge lamp generating the flickering is observed.

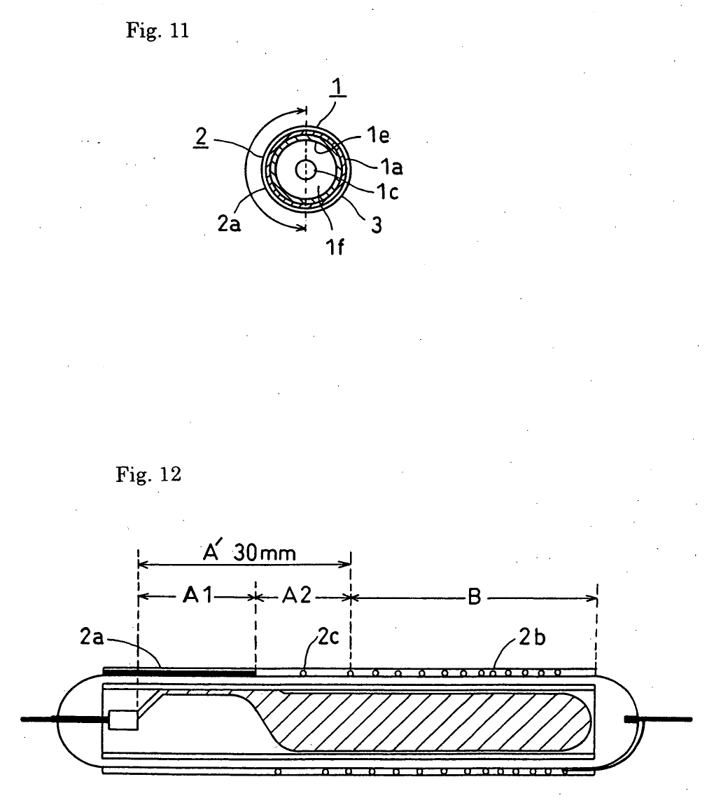

FIG. 10 and FIG. 11 show the second embodiment of the discharge lamp according to the present invention. FIG. 10 is a side view. FIG. 11 is a cross section along the A-A′ line in FIG. 10. In each figure, the same symbols are assigned to the corresponding portions to those in FIG. 6 to FIG. 8, thereby omitting explanations thereof. The second embodiment is different from the first embodiment in that the outer electrode 2 in the first area 2a is made in the shape of a belt. This outer electrode 2a uses such a reflective belt as an aluminum foil, thereby increasing the amount of a light reflected to make the luminous distribution uniform.

FIG. 12 is a longitudinal section of a discharge lamp showing the third embodiment of the present invention. In the figure, the same symbols are assigned to the corresponding portions to those in FIG. 8, thereby omitting explanations thereof. The third embodiment is different from the first and second embodiments in that the third area 2c is inserted between the first area 2a and the second area 2b of the outer electrode 2. Similar to the first area 2a or the second area 2b, the third area 2c consists of such a conductive metal wire as nickel, and is wound in the shape of a coil like the second area 2b. Here, the pitch of the coil is arranged as 4 mm/turn or larger, and is made larger than the pitch of the second area 2b. Here, the length A1 along the tube axis of the first area 2a is 2 to 10 mm long. The sum A′ of the length A1 and A2 along the tube axis of the third area 2c is about 30 mm long.

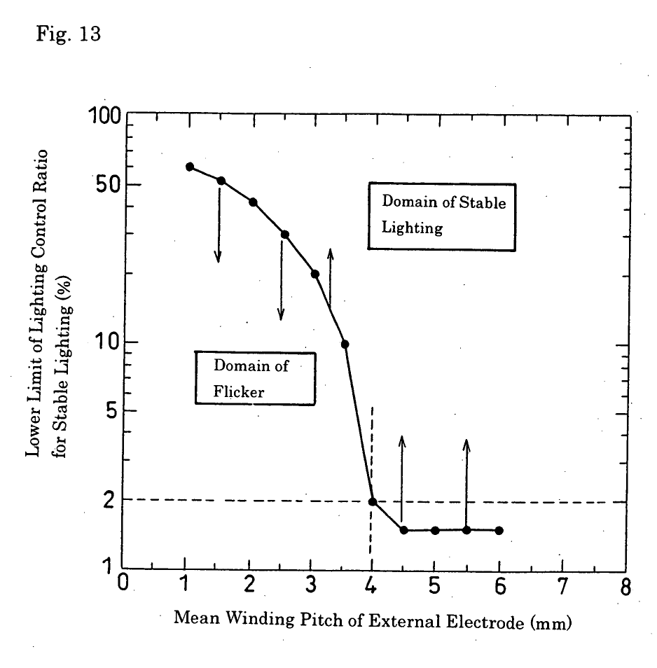

FIG. 13 is a graph showing results of measurements of the relation between the average winding pitch (abscissa) of the third area 2c and lighting control ratio D (ordinate). That is, the graph is obtained by plotting the lower limit of the lighting control ratio for stable lighting, which is the value of lighting control ratio at which the flicker occurs, when lighting control ratio D is varied for the arbitrary average winding pitches of the third area 2c. Here, this graph shows the results of measurements when the whole section of length A′ containing the first area 2a is occupied by the third area 2c. It became clear from this graph that the flicker is apt to occur and a stable discharge cannot be obtained, when the average winding pitch of the third area 2c is smaller than a boundary pitch of 4 mm/turn, and when the lighting control ratio D is as low as about 2%, for example. On the contrary, it is also clear that the stable discharge free of flicker is obtained, when the average winding pitch of the third area 2c is 4 mm/turn or larger, and when the lighting control ratio D is 2% or less. The reason for the results is supposed that the electric power supplied into the translucent airtight container 1a from the third area 2c which constitutes the outer electrode 2 is smaller than the electric power supplied from the second area 2b, because the third area 2c has a larger average winding pitch than the second area 2b. For this reason, the generation of a contracted positive column is suppressed in the translucent airtight container 1a.

Thus, the generation of the contracted positive column was suppressed by providing the third area 2c between first area 2a and second area 2b in the outer electrode 2. Even when it is generated despite the suppression by the third area 2c, drawing the contracted positive column to fix on the inner wall of the translucent airtight vessel 1a can prevent the flicker.

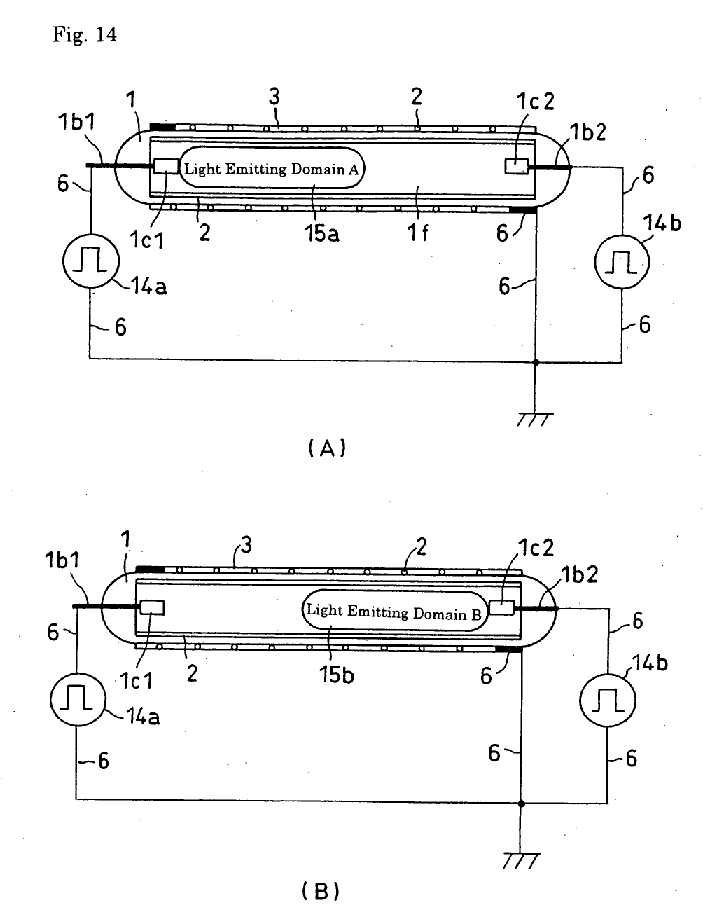

FIG. 14 is a side cross section showing a structure of a discharge lamp used in the fourth embodiment of the present invention. The discharge lamp according to the fourth embodiment has the first and second inner electrodes 1c1, 1c2 formed in the ends of translucent airtight vessel 1a, and has lead-in wires 1b1 and 1b2, each of which is connected to each of the first and second inner electrodes 1c1, 1c2 at their one end, and are led out of the translucent airtight vessel 1a at their other end. A phosphor layer 1e is formed on the inner surface of translucent airtight vessel 1a. The outer electrode 2 is spirally wound around the outer surface of the translucent airtight vessel 1a, the outer surface of which is coated with the translucent insulation cover 3.

A first and a second high frequency pulse power sources 14A and 14B are provided, which supply the high frequency pulse for driving the lamps. The first high frequency pulse power source 14A is connected through a voltage supply line 6 between lead-in wire 1b 1 connected to the first inner electrode 1c1, and one end of the outer electrode 2. Then, the second high frequency pulse power source 14B is connected through the voltage supply line 6 between the lead-in wire 1b2 connected to the second inner electrode 1c2, and one end of the outer electrode 2. The first and second high frequency pulse power sources 14a and 14b are controlled by a control device (not illustrated) to operate by turns at a predetermined cycle. That is, a first state of operation, where the first high frequency pulse power source 14a operates and the second high frequency pulse power source 14b stops to operate, and a second state of operation, where the first high frequency pulse power source 14a stops to operate, and the second high frequency pulse power source 14b operates, are repeated in a constant cycle.

In the first state of operation of the discharge lamp described, the electric discharge arises between the first inner electrode 1c1 and the outer electrode 2, where the luminescence area 15a is extended into the electric discharge space 1f from first inner electrode 1c1, as shown in FIG. 14(A). In the second state of operation, the electric discharge arises between the second inner electrode 1c2 and the outer electrode 2, where the luminescence area 15b is extended into the electric discharge space 1f from the second inner electrode 1c2 as shown in FIG. 14(B).

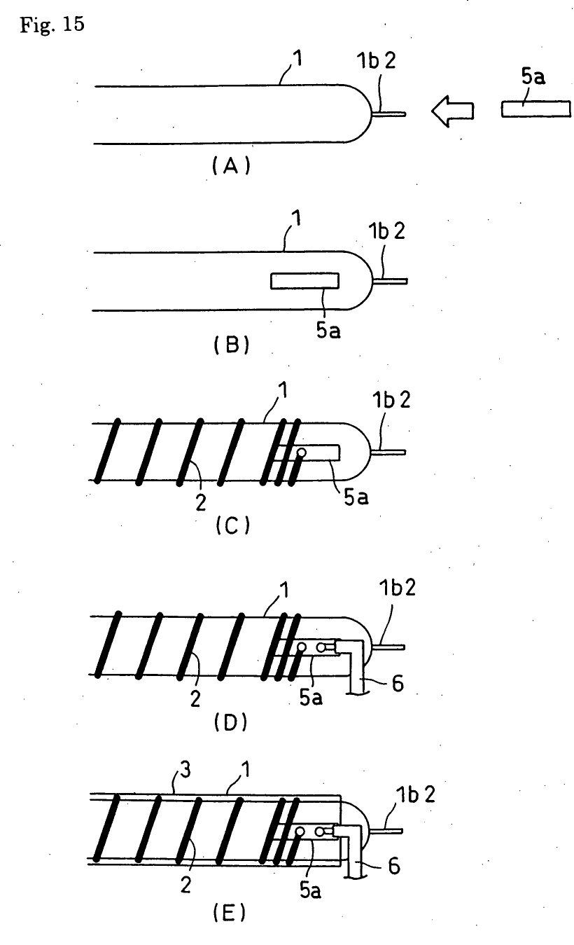

FIG. 15 is a partial side view showing a structure of an outer electrode of an electric discharge lamp according to the fourth embodiment of the present invention. In FIG. 15, figures (A) to (D) show a process for manufacturing a discharge lamp, and figure (E) shows a finished product.

A structure of a connecting part of the outer electrode with a voltage supply line is improved in this embodiment. The structure of the lamp other than the connecting part is the same as that of the fourth embodiment. Thus, the same symbols are assigned to the same portions to omit the detailed explanation thereof.

As shown in FIG. 15(A) and (B), a board-like metal segment 5a is installed at the end of the electric discharge lamp 1 which consists of a glass tube. This metal section 5a has a long and slender form linearly extended along the tube axis of the discharge lamp 1, which is corresponding to outer electrode 2a of the shape of a straight line in first area 2a shown in FIG. 6, or to the belt like outer electrode 2a shown in FIG. 10. This metal segment 5a is being fixed to the outer wall of the discharge lamp 1 using, for example, adhesive.

Next, an outer electrode 2 made of a metal wire is spirally wound around the outer surface of the electric discharge lamp 1, the end of which is fixed on the metal segment 5a using, for example, adhesive, as shown in FIG. 15(C). Alternatively, the end of the outer electrode 2 may be fixed with adhesive on the surface of the discharge lamp 1 (not illustrated). The outer electrode 2 is wound with more than a few turns at the portion of metal section 5a to fix the metal section 5a on the discharge lamp 1 as well as to secure the electric conduction between them.

Then, the voltage supply line 6, which is connected to the high frequency power source (not illustrated) for driving a discharge lamp is soldered on the metal segment 5a as shown in FIG. 15(D), thereby electric conduction between both of them is secured.

The outer electrode 2 and metal segment 5a are so pressed as to be fixed to the discharge lamp 1 by being covered with the translucent contraction tube 3, as shown in FIG. 15(E)

The contracted positive column generated in the discharge lamp 1 can be attracted, and thus the flickering can be suppressed by connecting the outer electrode 2 with the voltage supply line 6 through the metal segment 5a in a straight-line form, on which concentration of the electromagnetic field takes place.

With this connection structure, disconnection is prevented caused by the fact that the outer electrode 2 made of a thin metal wire having a diameter 0.5 mm or less is pulled through the voltage supply line 6. Further, the fluorescent lamp which has the desired luminescence distribution characteristic along the tube axis direction of the discharge lamp 1 is obtained since a misalignment of the outer electrode 2 from the predetermined position of the discharge lamp 1, which is caused by the fact described, can be prevented.

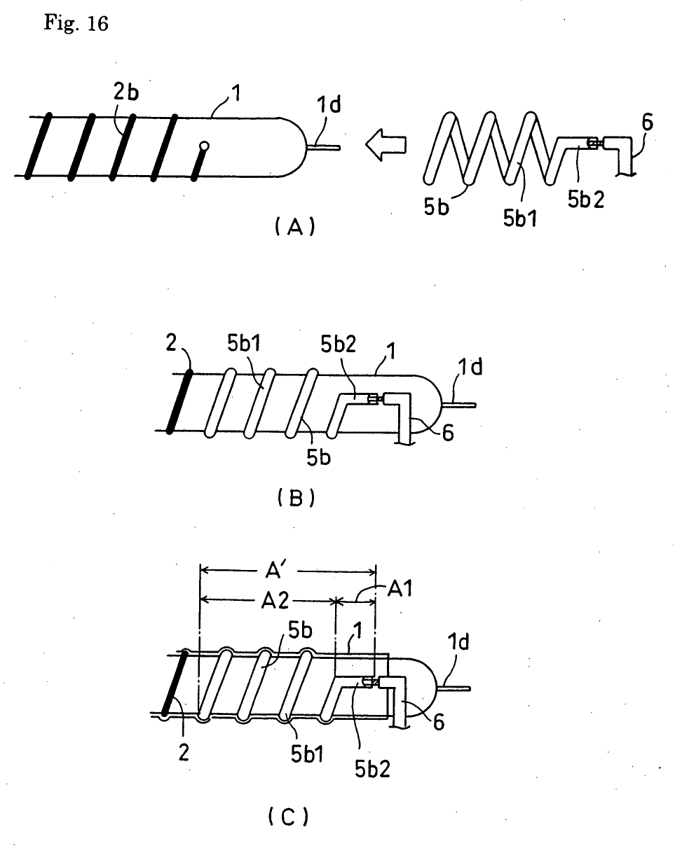

FIG. 16 is a side view of a discharge lamp showing the fifth embodiment of the present invention. FIG. 16 is an enlarged view showing the construction of the connecting part of an outer electrode with a voltage supply line as in the embodiment shown in FIG. 14 and FIG. 15. Thus, in the figure, the same symbols are assigned to the same portions as those in FIG. 14 and FIG. 15, and detailed explanation is omitted.

Segment 5b consists of a spring part 5b1 and a straight-line part 5b2 extended in the direction of an axis of the discharge lamp 1, as shown in FIG. 16(A). The spring part 5b1 of the metal segment 5b and straight-line part 5b2 correspond to the third area 2c of the outer electrode 2 and the first area 2a which were explained in the embodiment of FIG. 12, respectively. That is, the winding pitch of the spring part 5b1 is selected as 4 mm/turn or more, which is larger than the pitch of the second area 2b, as already explained in the embodiment with reference to FIG. 12. The total length A′ of the metal section 5b along the tube axis is about 30 mm. The length A1 of the straight line part 5b2 along the tube axis is 2 to 10 mm, and the length A2 of the spring part 5b1 along the tube axis is equal to the rest of the length A′.

The voltage supply line 6 is connected to the straight-line part 5b2 of the metal section 5b by a soldering process. Thus, the metal section 5b of the spring shape thus composed is coupled to the end portion of the discharge lamp 1 around which the outer electrode 2 is wound, having an overlapping portion with the outer electrode 2. The overlapping portion establishes electric conduction between the outer electrode 2 and metal section 5b. Further, the outer electrode 2 and metal section 5b are covered by a translucent heat shrinkage tube 3 and are suppressed to be fixed on the discharge lamp 1, as shown in FIG. 16(C). Here, the connection between spring metal section 5b and the voltage supply line 6 may be made after the spring metal section 5b is mounted on the discharge lamp 1.

Thus, spring shaped metal segment 5b suppresses the generation of the contracted positive column by the spring part 5b1, and attracts the contracted positive column once generated in the discharge lamp 1 by the straight line part 5b2, thereby preventing the flickering.

With this connection structure, in which the outer electrode 2 is connected to the voltage supply line 6 through the spring metal segment 5b, disconnection or displacement of the outer electrode 2 is prevented, which may be caused by the fact that the outer electrode 2 made of a thin metal wire is pulled through the voltage supply line 6 as explained with respect to the fourth embodiment shown in FIG. 15. Further, with this connection structure, the fluorescent lamp, which has the desired luminescence distribution characteristic along the tube axis of the discharge lamp 1, is obtained.

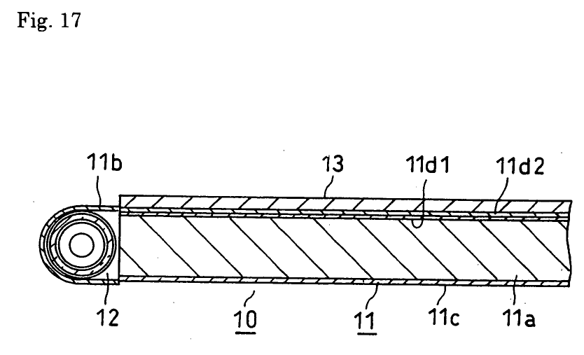

FIG. 17 is a sectional view showing the back light unit for a liquid crystal display, which is an embodiment of a lighting device according to the present invention. As shown in the figure, a back light unit 10 for the liquid crystal display device is composed of a main body 11 of back light unit 10, a discharge lamp 12, a liquid crystal display unit 13 and a lighting circuit (not illustrated). Here, the discharge lamp 12 is any one of the fluorescent lamps shown in FIG. 7 through FIG. 9.

The main body 11 includes a light guide 11a, a trough like reflective board 11b, back reflective sheet 11c, diffusion sheet 11d1, and a light collecting sheet 11d2, and is contained in a case (not illustrated).

The light guide 11a consists of a transparent body, which has high refractive indices, such as a transparent acrylic resin and polycarbonate resin. The trough like reflective board 11b is so provided that a light emitted from the discharge lamp 12 may be guided into the light guide 11a and may not leak to a part other than the light guide 11a. The back reflective sheet 11c reflects the light, which is emitted from the back of the light guide 11a, so that it is emitted from the front of the light guide 11a. Moreover, the reflectance of back reflective sheet 11c is partially controlled so that the light may be emitted uniformly from the whole front surface of the light guide 11a. Diffusion sheet 11d1 is provided in front of the light guide 11a, so that it may diffuse the light, which is emitted forward from the light guide 11a to provide a uniform luminosity distribution. The light collecting sheet 11d2 collects the light emitted from the diffusion sheet 11d1, so that incidence efficiency of the light into the liquid crystal display part 13 may be improved.

The liquid crystal display unit 13 is piled on the front surface of the main body 11 of the back light device, and is illuminated by the main body 11 from the back; thereby a liquid crystal display of a penetration type is performed.

1. A discharge lamp comprising:
a tubular translucent air tight vessel,
an inner electrode sealed in at least one end of the translucent air tight vessel,
a discharge medium composed mainly of rare gas and sealed inside the translucent air tight vessel, and
an outer electrode composed of a conductor wire which is wound around an outer surface of the translucent air tight vessel, having a first area, which extends in a range between a top end of the inner electrode and a position having a predetermined length in the forward direction of the translucent air tight vessel, and a second area, which extends in the rest of the length of the translucent air tight vessel,
wherein the conductor wire is placed within a half circumference of the translucent air tight vessel in the first area, and wherein the conductor wire is placed within the entire circumference of the translucent air tight vessel in a second area.

2. A discharge lamp according to claim 1, wherein the conductive wire forming the outer electrode is arranged linearly along the tube axis on the outer surface of the translucent air tight vessel in the first area, and is wound around the translucent air tight vessel in a coil shape in the second area.

3. A discharge lamp according to claim 2, wherein the length of the first area is equal to or less than 30 mm.

4. A discharge lamp according to either one of claims 1 to 3, wherein the outer electrode includes a third area between the first area and the second area, wherein the conductive wire of the outer electrode is wound around the translucent airtight vessel in a coil shape, and wherein the winding pitch of the conductive wire in the third area is larger than the winding pitch of the conductive wire in the second area.

5. A discharge lamp according to claim 4, wherein the total length of the first area and the third area is equal to or less than 30 mm.

6. A discharge lamp according to claim 2, wherein the conductive wire of the outer electrode is composed of a belt shape conductor arranged linearly along the tube axis on the outer surface of the translucent air tight vessel in the first area.

7. A discharge lamp according to claim 4, wherein the conductive wire of the outer electrode is composed of a belt shape metal segment which is arranged linearly along the tube axis on the outer surface of the translucent air tight vessel in the first area.

8. A discharge lamp according to claim 7, wherein the conductive wire of the second area is connected with the metal segment.

9. A discharge lamp according to claim 8, wherein the conductive wire of the outer electrode is composed of a metal segment of spring shape in the third area, and is formed integrally with the linear metal segment in the first area.

10. A discharge lamp according to claim 7, wherein the metal segment of spring shape is arranged to overlap with the conductive wire in the second area by some portion, so that they are connected electrically with each other.

11. A discharge lamp according to claim 8 or claim 10, wherein the metal segment is more rigid than the metal conductive wire in the second area.

12. A discharge lamp according to claim 1 or claim 11, wherein the translucent vessel is composed of glass tube.

13. A discharge lamp according to any one of the claims 1 to 12, wherein the outer surface of the translucent air tight vessel is covered with a translucent insulator coating.

14. A discharge lamp according to any one of the claims 1 to 13, wherein the translucent insulator coating is composed of a heat shrinkage type tube.

15. A discharge lamp according to any one of the claims 1 to 14, wherein the heat shrinkage type tube is composed of heat shrinkage type fluorocarbon resin.

16. A lighting device comprising:
a main body,
a discharge lamp provided in the main body according to any one of the claims 1 to 15, and
a lighting circuit for lighting the discharge lamp.
